(19) United States
(12) Patent Application Publication
(10) Pub. No.: US 2010/0232005 A1
(43) Pub. Date: Sep. 16, 2010

(54) Speckle Reduction in Display Systems Using Transverse Phase Modulation in A Non-Image Plane

(75) Inventors: Alban N. Lescure, Redmond, WA (US); Mark O. Freeman, Snohomish, WA (US); Christian Dean DeJong, Sammamish, WA (US); Maarten Niesten, Kirkland, WA (US); Joshua M. Hudman, Sammamish, WA (US)

Correspondence Address: MICROVISION, INC., 6222 185TH AVENUE NE, REDMOND, WA, 98052, US

(73) Assignee: Microvision, Inc., Redmond, WA (US)

(21) Appl. No.: 12/402,737

(22) Filed: Mar. 12, 2009

(51) Int. Cl. G02F 1/01; G02B 27/20

(52) U.S. Cl. 359/279; 362/259

(57) ABSTRACT

Briefly, in accordance with one or more embodiments, a scanned beam display comprises one or more light sources to generate one or more light beams, a scanner module to receive the one or more light beams to generate a displayed image via scanning of the light beams onto a projection surface, and a spatial phase modulator disposed between the light source and the scanner module to phase modulate the one or more light beams to provide speckle reduction in the display image projected onto the projection surface.

### BACKGROUND

Laser based scanned beam displays typically may exhibit an artifact in the image known as speckle. Speckle is as a pattern of random intensities appearing in the projected image via interference at the plane of a display surface of the wavefronts of the scanned beam, for example via scattering of the beam off of the display surface having a surface plane that is not perfectly smooth.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1A and FIG. 1B are block diagrams of scanned beam projector capable of providing speckle reduction using a transmissive or a reflective spatial phase modulator, respectively in accordance with one or more embodiments;

FIG. 2 is a block diagram of a scanned beam projector capable of providing speckle reduction using a spatial phase modulator on one or more laser beam colors in accordance with one or more embodiments;

FIG. 3 is a block diagram of a scanned beam projector capable of providing speckle reduction using a spatial phase modulator at a surface of a scanner in accordance with one or more embodiments;

FIG. 4 is a diagram of a tilt as an example of a simple phase profile of a reflective spatial phase modulator in a first phase state in accordance with one or more embodiments;

FIG. 5 is a diagram of a tilt in the opposite direction to that of FIG. 4 as a second example of a simple phase profile of a reflective spatial phase modulator in a second phase state in accordance with one or more embodiments;

FIG. 6 illustrates beam sizes at various distances of a scanned beam display from a projection surface after time averaging in accordance with one or more embodiments.

FIG. 7A and FIG. 7B are an example phase profile of a relatively random phase modulation pattern and a resulting pixel in the image plane, respectively, in accordance with one or more embodiments; and

FIG. 8A and FIG. 8B are an example phase profile of a binary phase modulation pattern and a resulting pixel in the image plane, respectively, in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

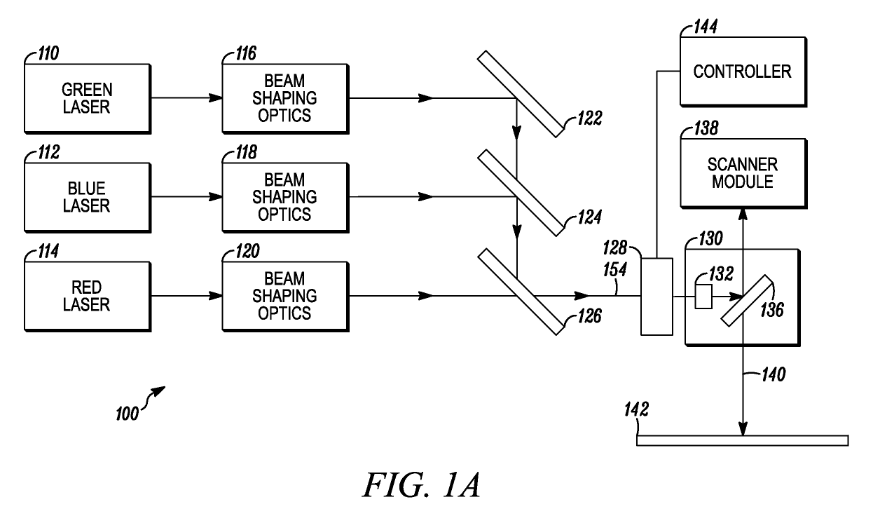

Referring now to FIG. 1A and FIG. 1B, block diagrams of a scanned beam projector capable of providing speckle reduction using a transmissive or a reflective spatial phase modulator, respectively, in accordance with one or more embodiments will be discussed. As shown in FIGS. 1A and/or 1B, scanned beam projector 100 may include one or more laser sources to generate laser beams that are used to generate a scanned image projected onto a display surface 142. In one or more embodiments, scanned beam projector 100 may utilize a raster scan to generate a projected image, and in one or more alternative embodiments, scanned beam projector 100 may utilize a vector scan to generate a projected image, although the scope of the claimed subject matter is not limited in this respect.

In one or more embodiments, scanned beam projector 100 may include two or more lasers to generate a multi-color displayed image. In the embodiment shown, scanned beam projector 100 may include a green laser 110, a blue 112, and/or a red laser 114, for example to generate a red-green-blue (RGB) color image. The lasers may emit a laser beam of its respective color in which beam shaping optics 116, beam shaping optics 118, and/or beam shaping optics 120 may be disposed in the emitted beam path of the green laser 110, blue laser 112, and/or the red laser 114, respectively. For example, the beam shaping optics may include a beam collimator, a circularizer, a top-hat lens, a polarizer, and so on to shape or control the emitted beam to have a desired characteristic or profile. After passing through beam shaping optics 116, the green laser beam may be reflected off of a reflector 122 and combined with the blue laser beam emitted from beam shaping optics 118 via combiner 124. Likewise, the combined green/blue laser beams may be combined with the red laser beam emitted from beam shaping optics 120 via combiner 126 to be directed toward scanner module 138 for scanning. In one or more embodiments, scanner module 138 may comprise a microelectromechanical system (MEMS) scanner, however other types of scanning technologies may likewise be utilized, and the scope of the claimed subject matter is not limited in this respect.

The combined laser beam 154 may pass through a transmissive phase modulator 128 before it is incident onto scanner module 138. In accordance with one or more embodiments, transmissive phase modulator 128 is capable of performing transverse phase modulation on the combined laser beam 154 prior to being scanned by scanner module 138 which scans the beam to generate a projected image and before the beam reaches the image plane located on projection surface 142 in order to reduce or eliminate speckle in the projected image. In one or more embodiments, speckle may be defined herein as a pattern of random intensities appearing in the projected image via interference at the plane of display surface 142 of the wavefronts of the scanned beam 140, for example via scattering of the beam off of projector surface 142 having a surface that is not perfectly smooth.

In one or more embodiments, the combined laser beam 154 may be directed onto the scanner module 138 which in turn may scan the projected beam 140 onto projector surface. An optional optic 132 may be provided at the point of entry of the laser beam 154 into beam coupler 130, for example to provide focusing of laser beam 154 or to provide a clipping aperture to allow for a desired amount of clipping of laser beam 154 and/or to couple laser beam 154 to scanner module 138. In one or more embodiments, modulation states of the modulator and aperture size may be utilized in combination to result in the same or nearly the same intensity of the laser beam 154 for all or nearly all of the modulation states. After entering beam redirector 130, laser beam 154 may be redirected via one or more reflector surfaces to impinge on scanner module 138. In one or more embodiments, a reflective spatial phase modulator 134 may be utilized to implement at least part of the redirection of laser beam 154, for example to provide the functions of a fold mirror, and/or to provide transverse phase modulation of laser beam 154 to reduce or eliminate speckle in the projected image in a manner substantially similar to transmissive phase modulator 128 except that reflective phase modulator is reflective rather than transmissive. An internal reflector 138 may redirect the laser beam emitted from reflective spatial phase modulator 134 to impinge on scanner module 138 at a desired input angle suitable for scanning by scanner module 138. In one or more embodiments, scanner module 138 comprises one or two one-dimensional (1-D) scanners or alternatively a two-dimensional (2-D) scanner capable of being modulated to redirect the laser beam into a controlled pattern to generate the projected image at projection surface 142 that may be a one-dimensional or a two-dimensional image. In one or more embodiments, scanner module 138 may be driven to operate resonantly in one or more dimensions, or alternatively may be driven to operate non-resonantly in one or more dimensions, and the scope of the claimed subject matter is not limited in this respect. A controller 144 of scanned beam display 100 may be utilized to control transmissive spatial phase modulator 128 and/or reflective spatial phase modulator 134 to control the amount of transverse phase modulation of laser beam 154 to result in a desired amount of speckle reduction.

In accordance with one or more embodiments, speckle reduction may be accomplished via the averaging of multiple speckle patterns with the eye. In such embodiments, multiple speckle patterns may be presented to the eye wherein the speckle patterns are changed or modulated within the integration time, also known as persistence, of the image presented to the eye. The multiple speckle patterns are created by changing the modulation pattern or profile of the spatial phase modulator such as transmissive spatial phase modulator 128 and/or reflective spatial phase modulator 134. Furthermore, it should be noted that in accordance with one or more embodiments the spatial phase modulators discussed herein such as spatial phase modulator 128 and/or reflective spatial phase modulator 134, at least in part in some embodiments and entirely in other embodiments, are not disposed in an image plane such as at projection surface 142. Thus, in one or more embodiments, the modulation pattern may be changed at a location other than at the image plane, although the scope of the claimed subject matter is not limited in this respect.

In one or more embodiments, one or both of transmissive spatial phase modulator 128 and/or reflective spatial phase modulator 134 may comprise various structures or apparatuses that are capable of controlling the transverse phase of the laser beam 154. For example, the spatial phase modulators may comprise a multi-pixel phase modulator for a combined laser beam path before laser beam 154 reaches scanner module 138. Possible technologies for transmissive spatial phase modulator 128 and/or reflective spatial phase modulator 134 may include liquid crystal devices such as a nematic liquid crystal (NLC) device or a ferroelectric liquid crystal (FLC) device, other electro-optic materials, a flexible membrane, a transmissive device with locally addressable index of refraction, a reflective device with locally addressable index of refraction, a pixilated device comprising multiple plungers each of which is capable of being actuated to reflect laser beam 154 from different longitudinal positions, a single cell liquid crystal (LC) device comprising an electrode on one surface sufficient enough resistance such that different voltages placed on two sides of the electrode will cause a gradient or varying electric field to be imposed across the LC cell, among many examples. In some embodiments, reflective spatial modulator 134 may comprise a single cell such as a reflective membrane the surface profile of which may be deformed for example by electrical actuation or mechanical actuation. In alternative embodiments, spatial phase modulator 128 and/or spatial phase modulator 134 may comprise a diffraction grating or blazed diffracting grating that induces a tilt in order to alter the phase of the light beam 154. In some embodiments, spatial phase modulator 128 and/or spatial phase modulator 134 may comprise an acoustically actuated device to select the desired modulation states of the modulators. In some particular embodiments, reflective spatial phase modulator 134 may comprise a liquid crystal phase modulator utilized as a fold mirror by compensating for the angle of incidence of laser beam 154 on the liquid crystal. However, these are merely example tangible embodiments of transmissive spatial phase modulator 128 and/or reflective spatial phase modulator 134, and the scope of the claimed subject matter is not limited in this respect.

In one or more embodiments, spatial phase modulator 128 and/or spatial phase modulator 134 may be capable of implementing spatial phase modulation on laser beam 154 without affecting the beam size and/or quality. For example, spatial phase modulator 128 and/or spatial phase modulator 134 may comprise a single pixel liquid crystal phase modulator for scanned beam projector 100. In such a spatial phase modulator, there will be two polarizations states of the modulator. Therefore, the beam quality will not be affected, and the spot size will not change. In some embodiments, more allowance may be provided for spot size growth for the vertical direction than for the horizontal direction, although the scope of the claimed subject matter is not limited in this respect.

In some embodiments, spatial phase modulator 128 and/or spatial phase modulator 134 may be utilized to optimize both phase modulation and polarization modulation. The added polarization diversity that can be achieved using the modulator in this way can further reduce speckle via polarization diversity. Some liquid crystal modulators can be configured to both modulate the spatial phase profile and also change the polarization profile.

The modulation states of spatial phase modulator 128 and/or spatial phase modulator 134 may be designed to be orthogonal or as orthogonal as possible for the highest or nearly highest speckle reduction effect. In such an arrangement, the term orthogonal may refer to independent states where a maximum or nearly maximum potential speckle reduction may be achieved such that the states are at least partially or completely uncorrelated and/or produce independent or nearly independent speckle patterns for one or more of the states. By providing orthogonal or sufficiently different modulation states, N number of states may result a reduction in speckle contrast in an amount of 1/√N. If the speckle patterns induced by the spatial phase modulators may not be sufficiently different or orthogonal, which may result in at least a partial overlap of the modulation states and the speckle reduction may be somewhat less than 1/√N. In some embodiments, the modulation states of spatial phase modulator 128 and/or spatial phase modulator 134 may be orthogonal or nearly orthogonal to result in a speckle reduction of about 1/√N, and in other embodiments the modulation states of spatial phase modulator 128 and/or spatial phase modulator 134 may be somewhat less than orthogonal yet still yield a sufficient amount of speckle reduction that is acceptable to a user of scanned beam projector 100, and the scope of the claimed subject mater is not limited in this respect. In certain embodiment, the user may select from a set of preset modulation patterns to choose a modulation pattern results in speckle reduction that is amenable to the user. In some embodiment of scanned beam display 100, transmissive spatial phase modulator 128 and/or reflective spatial phase modulator may be designed in such a manner that the modulators are not sensitive to the polarization state of the incoming laser beam 154, and more specifically not sensitive to orthogonal polarization states of the incoming laser beam 154.

In one or more embodiments, spatial phase modulator 128 and/or spatial phase modulator 134 may be utilized to optimize both the phase modulation and polarization modulation such that further speckle reduction may be accomplished by using polarization modulation to induce polarization variations in the speckle patterns. In such embodiments, an additional modulation apparatus may be utilized to provide polarization modulation that is separate from spatial phase modulator 128 and/or spatial phase modulator 134, or alternatively the polarization modulation may be accomplished via the same device that also provides phase modulation. For example spatial phase modulator 128 and/or spatial phase modulator 134 may comprise a liquid crystal device that is capable of modulating both the spatial phase and the polarization of laser beam 154, although the scope of the claimed subject matter is not limited in this respect.

In some embodiments of scanned beam display 100, orthogonal phase modulation states for spatial phase modulator 128 and/or spatial phase modulator 134 may be obtained by using Hadamard transforms, Hermite, Laguerre, and/or Zernike polynomials, or combinations thereof. In particular embodiments, modulation states for modulator 128 and/or modulator 134 may be selected to be free-space Eigen functions so that the laser beam 154 will propagate at greater efficiency. In certain embodiments, a combination of the selected modulation states of spatial phase modulator 128 and/or spatial phase modulator 134 with the aperture size for laser beam 154 may be selected to optimize a desired amount of speckle reduction. For example, optic 132 may include a clipping aperture to provide an appropriate aperture for laser beam 154 in combination with the modulation states.

In one or more embodiments, scanned beam display 100 may comprise spatial phase modulator 128 and/or spatial phase modulator 134 that is capable of modulating both polarization and phase as a single device. In some embodiments, modulator 128 and/or modulator 134 may be capable of implementing continuous or analog phase modulation states and/or discrete phase modulation states such as binary quantized phase modulation and/or multi-state quantized phase modulation. In some embodiments, spatial phase modulator 128 and/or spatial phase modulator 134 may comprise a single phase modulator device capable of modulating two or more colors such as all three RGB colors, optionally in an optimum arrangement for two or more colors, for example by having each individual beam hit the spatial phase modulator at a slightly different angle. In one or more alternative embodiments, speckle reduction may be obtained through a separate phase modulator and polarization modulator.

In one or more embodiments, transmissive spatial phase modulator 128 and/or reflective spatial phase modulator 134 may be designed, along with the selected modulation states, so that the spot growth of laser beam 154 is minimized or nearly minimized. Furthermore, in some embodiments, modulator 128 and/or modulator 134 may be designed, along with the modulation state, so that impact to the resolution of the image projected by scanned beam projector 100 is minimized or nearly minimized. For example, in some embodiments, changes to the spot size in the vertical direction may be limited to the vertical direction, where the spot can grow in a vertical direction without impacting resolution of the displayed image. In some embodiments, vertical spot growth may be selected and/or optimized to reduce raster pinch issues in the raster scan. In some embodiments, spatial phase modulator 128 and/or spatial phase modulator 134 may be designed, along with the modulation states, so that any spot growth may be constant or nearly constant in all or nearly all modulation states. In some particular embodiments, the user of scanned beam display may be capable of manually adjusting the spot growth to achieve a desired ratio of pixel size to spot size that is visually appealing to the user for a given projection distance, image content, specific screen material of display surface 142, personal preference, lighting conditions, and so on. In some embodiments, the set of adjustments used could be optimized for the particular application and/or customer, for example to optimize efficiency, spot size growth, polarization, and so on. In some embodiments, scanned beam display 100 could be adapted for non-projection applications, for example in eyewear or head-up displays (HUD), and so on, wherein the shape of the spot and the energy distribution in the spot may impact performance. In such embodiments, scanned beam projector may include a control to allow optimization which may be set during manufacturing, and/or which may be user adjustable for example to provide adjustments over the life scanned beam display and/or for each individual user optimize his or her experience. In some embodiments, an additional adjustment mechanism may be provided to allow altering the polarization of laser beam. In some embodiments, such adjustments may be performed statically, that is adjusted to a fixed setting, or dynamically in which adjustments are continually made as needed, for example via feedback into controller 144 to dynamically alter the spot growth and/or to reduce speckle. In such embodiments, a feedback mechanism may be used to obtain an indication of the amount of speckle and/or spot size such as proximity detection, machine vision, and so on, and the scope of the claimed subject matter is not limited in these respects.

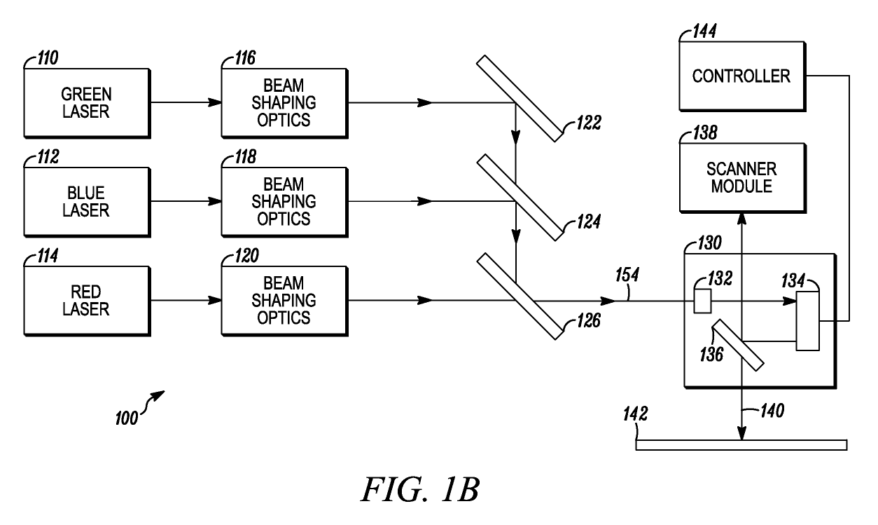

Referring now to FIG. 2, a block diagram of a scanned beam projector capable of providing speckle reduction using a spatial phase modulator on one or more laser beam colors in accordance with one or more embodiments will be discussed. In the embodiment of scanned beam display 100 of FIG. 2, a spatial phase modulator may be disposed in the path of one or more individual laser beam colors, for example spatial phase modulator 146 in the path of the green laser beam, spatial phase modulator 148 in the path of the blue laser beam, and/or spatial phase modulator 150 in the path of the red laser beam. In this way phase, which is related to wavelength, can be separately optimized for each wavelength with a separate phase modulator rather than a single modulator as shown in FIG. 1A and/or FIG. 1B. For example, in one particular embodiment spatial phase modulator 146 may provide a phase change of the green laser beam of about one green wavelength, or about 360 degrees, spatial phase modulator 148 may provide a phase change of one blue wavelength, or about 360 degrees, and spatial phase modulator 150 may provide a phase change of red wavelength, or about 360 degrees, as one particular example. With the single modulator of FIG. 1A and/or FIG. 1B, the 360 degree phase typically may be optimized for a single color. However, by using a modulator 146 for one or more separate colors as shown in FIG. 2, then the spatial phase modulation may be optimized for one or more of the colors separately, thereby being capable of resulting in additional speckle reduction. In certain embodiments, the phase modulator for a more critical color may be performed so that orthogonal speckle states can be achieved at least for this color. For example, green may be indicated as a critical color in one or more embodiments, in which case spatial phase modulator 146 may be utilized for the green laser beam, but not necessarily for the other color laser beams. In other embodiments, green and blue may be designated as the more critical colors, in which case spatial phase modulator 146 and spatial phase modulator 148 mat be utilized for the green laser beam and the blue laser beam, but not necessarily for the red laser beam. In the case where a spatial phase modulators is utilized on one or more individual color laser beams, orthogonal modulation stales may be utilized to optimize speckle reduction for individual colors. In some embodiments, spatial phase modulators 146, 148, and/or 150 may otherwise operate substantially similarly to the transmissive spatial phase modulator 128 and/or reflective spatial phase modulator 134 as shown in and described with respect to FIG. 1A and/or FIG. 1B, above, and may likewise comprise the same or substantially similar devices as the spatial phase modulators of FIG. 1A and/or FIG. 1B, and the scope of the claimed subject matter is not limited in these respects.

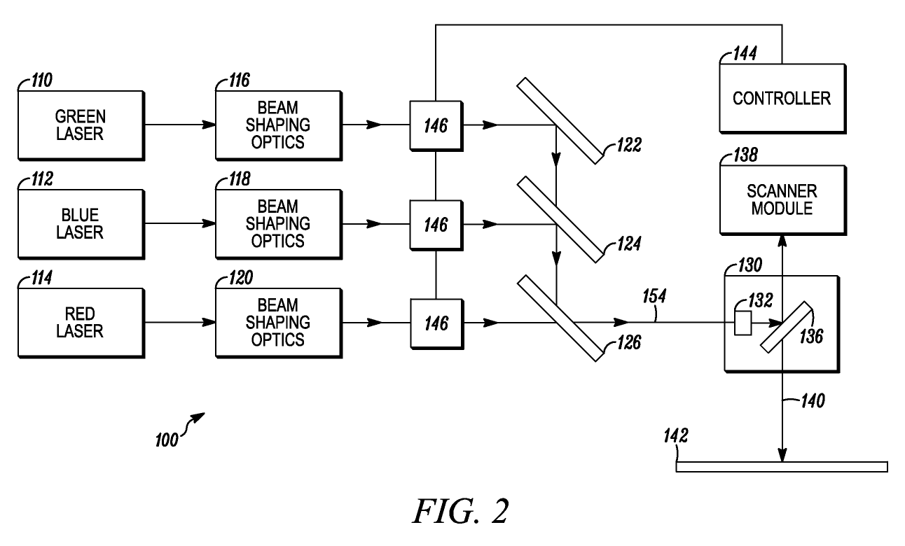

Referring now to FIG. 3, a block diagram of a scanned beam projector capable of providing speckle reduction using a spatial phase modulator at a surface of a scanner in accordance with one or more embodiments will be discussed. In the embodiment of scanned beam display 100 shown in FIG. 3, a spatial phase modulator 152 may be disposed at or on a surface of the reflector of the scanner mirror 138. Otherwise, spatial phase modulator 152 may operate the same as or substantially similar to transmissive spatial phase modulator 128 when disposed before scanner mirror 138 and/or reflective spatial phase modulator 134 when comprise the reflector of scanner mirror 138 of FIG. 1A and/or FIG. 1B, and/or the spatial phase modulators 146, 148, and/or 150 of FIG. 2, and may comprise the same or similar devices as such spatial phase modulators, and the scope of the claimed subject matter is not limited in these respects. In one or more of the embodiments of scanned beam display of FIG. 1A and/or FIG. 1B, FIG. 2, and/or FIG. 3, may comprise one or more spatial phase modulators disposed in the laser beam path and prior to scanner module 138 or disposed at the surface of the reflector of scanner module 138, as opposed to being disposed in the beam path and providing speckle reduction after the beam exits from scanner module 138. For example, the reflector plane of scanner module 138 may comprise a flexible reflective membrane such as Mylar or the like that is capable of being spatially modulated into two or more modulation states, for example via a suction or vacuum actuator, and so on. However these are merely example locations of the spatial phase modulators shown in FIG. 1A and/or FIG. 1B, FIG. 2, and/or FIG. 3, and the scope of the claimed subject matter is not limited in these respects.

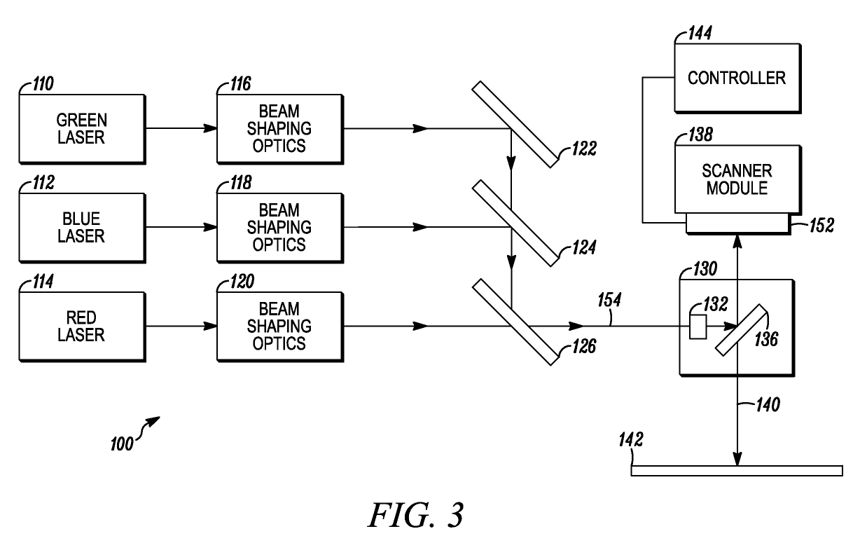

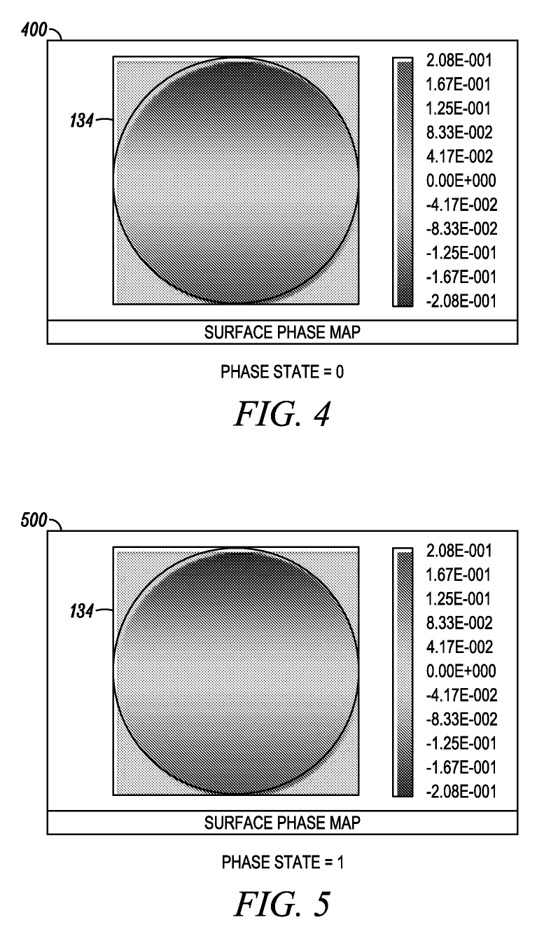

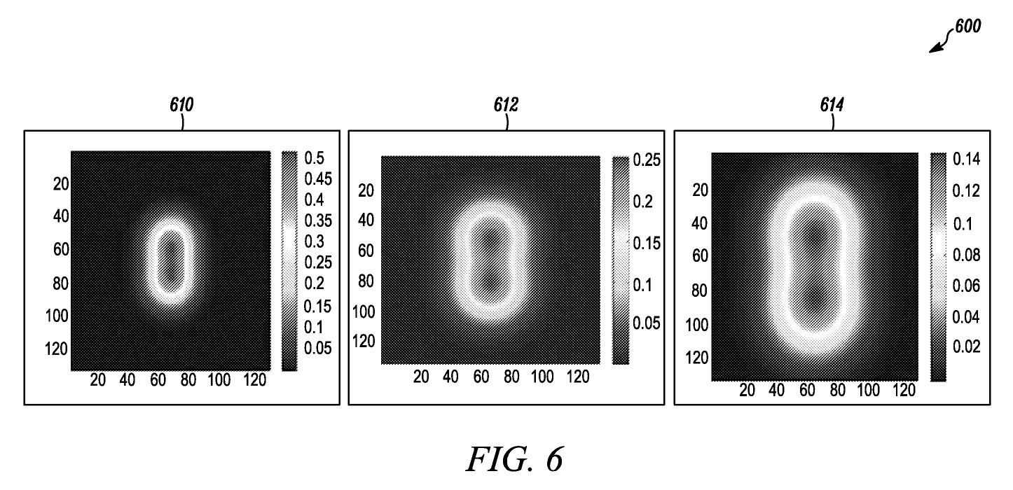

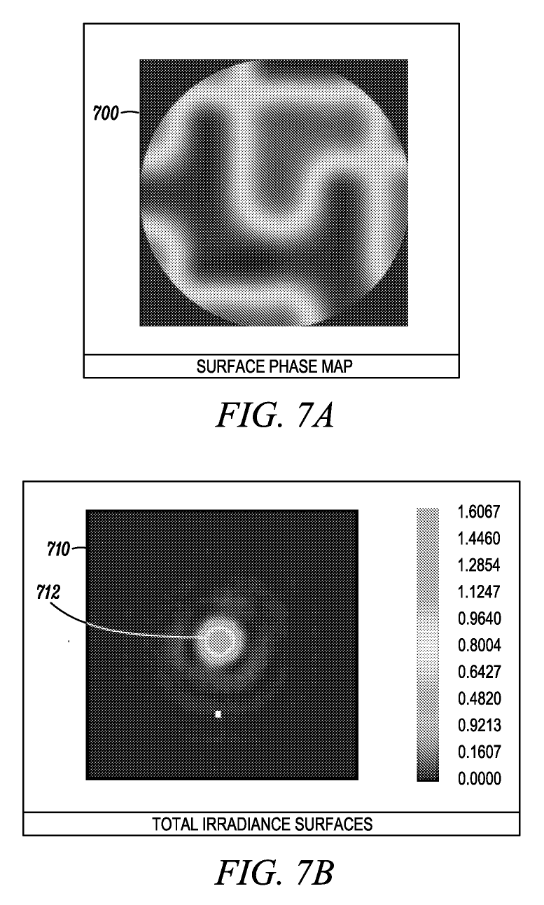

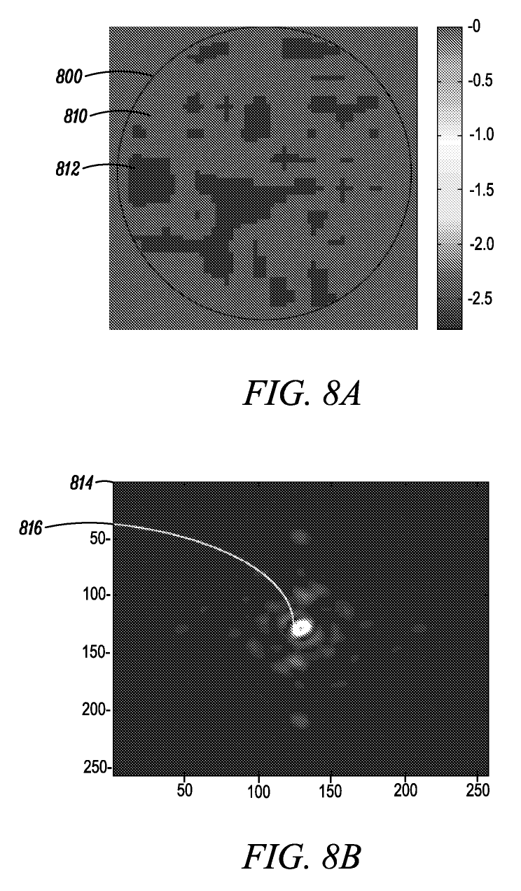

Referring now to FIG. 4 and FIG. 5, diagrams of a tilt in opposite directions as an example of a simple phase profile of a reflective spatial phase modulator in a first phase state and in a second phase state, respectively, in accordance with one or more embodiments will be discussed. The surface phase map 400 of FIG. 4 shows a basic, two phase reflective spatial phase modulator 134 in a first phase state, referred to as phase state=0. The surface phase map 500 of FIG. 5 shows the two phase reflective spatial phase modulator 134 in a second phase state, referred to as phase state =1. In one or more embodiments, reflective spatial phase modulator 134 may alternate between the two phase profiles with each frame change in the image displayed by scanned beam display, so that the modulator 134 will be in phase state=0 in a first frame, then may be in phase state=1 in the next frame, then may be in phase state=0 in the next frame, and then may be in phase state=1 in the next frame, and so, so that the phase state changes with each new frame. In the embodiment of reflective spatial phase modulator 134 of FIG. 4 and FIG. 5, an example modulator may comprise a reflective element having a diameter of about 1 mm or so, although the scope of the claimed subject matter is not limited in this respect. In one or more embodiments as shown in FIG. 4 and FIG. 5, reflective spatial phase modulator 134 implements a simple, binary state phase function and may be embodied, for example, by a flexible a mirror or reflective membrane having a piezoelectric actuator capable of deflecting a surface of the mirror or reflector in response to an applied voltage controlled by controller 144 to achieve spatial phase modulation to result in speckle reduction of the image displayed by scanned beam display. However, the embodiment shown in FIG. 4 and FIG. 5 is merely one example of a spatial phase modulator, and the scope of the claimed subject matter is not limited in this respect. It should be further noted that there may be multiple phase states used for speckle reduction, and not just two states shown in the examples of FIG. 4 and FIG. 5, and the examples in FIG. 6, FIG. 7A and 7B, and FIG. 8A and 8B, as discussed below. Furthermore, in one or more embodiments, the phase of laser beam 154 may be modulated such that the speckle pattern changes in alternating or succeeding video frames. However, this is merely one embodiment, and the speckle pattern alternatively may not change for every change in the video frame in one or more alternative embodiments. For example, the speckle pattern may be modulated to change at a rate faster than the video frame rate, or alternatively slower than the video frame rate. Thus, the rate of change of the speckle pattern may be changed to be tailored to the particular image content and/or to the particular application of projector 100 to obtain an optimal speckle reduction. In some embodiments, the user may adjust or select an appropriate rate of change of the speckle pattern in order to obtain a desired speckle reduction, although the scope of the claimed subject matter is not limited in this respect.

FIG. 6 illustrates beam sizes at various distances of a scanned beam display from a projection surface after time averaging in accordance with one or more embodiments. The plots 610, 612, and 614 of the beam size of laser beam 154 as shown in FIG. 6 are shown for distances of 1 meter, 1.5 meters, and 2 meters, respectively, of scanned beam projector 100 from display surface 142 using the reflective spatial phase modulator 134 as shown in FIG. 4 and FIG. 5. As can be seen in FIG. 6, spot size ratio of the vertical spot size to the horizontal spot size may be maintained over all, or nearly all distances. As a result, speckle reduction may be obtained without significantly affecting the relative spot size or shape of the beam emitted from scanned beam display 100. Furthermore, by allowing for some vertical growth in the beam spot size to achieve speckle reduction, raster pinch reduction may also be achieved. In one or more embodiments, the amount of speckle reduction and spot size growth may be adjusted by the manufacturer and/or by the user. Furthermore, using a spatial phase modulator as illustrated herein does not require any additional projection optics and/or any alteration of the design of scanner module 138 while still maintaining an infinite depth of focus (DOF) for scanned beam display, however the scope of the claimed subject matter is not limited in these respects. Furthermore, although the spatial phase modulators discussed herein comprise phase modulators, in one or more alternative embodiments the modulators may comprise amplitude modulators and/or a combination of phase and amplitude modulators, however the scope of the claimed subject matter is not limited in these respects. In some embodiments, the scanned beam display 100 capable of reducing speckle as discussed herein may be part of a computing platform wherein the computing platform comprises a processor and a memory coupled to the processor, and the scanned beam display is capable of displaying an image in response to a command from the processor to display image at least temporarily stored in said memory, although the scope of the claimed subject matter is not limited in this respect.

Referring now to FIG. 7A and FIG. 7B, an example phase profile of a relatively random phase modulation pattern and a resulting pixel in the image plane, respectively, in accordance with one or more embodiments will be discussed. As shown in FIG. 7A, surface phase map 700 represents an example phase profile of a relatively random phase modulation pattern capable of being implemented by one or more of the phase modulators described herein, for example transmissive spatial phase modulator 128 of FIG. 1A, reflective spatial phase modulator 134 of FIG. 1B, transmissive spatial phase modulators 146 of FIG. 2, and/or reflective spatial phase modulator 152 of FIG. 3, although the scope of the claimed subject matter is not limited in these respects. As shown in FIG. 7A, the resulting phase profile shown in surface phase map 700 may be more complicated and/or relatively more random than the phase profile shown in surface phase map 400 of FIG. 4 and/or surface phase map 500 of FIG. 5, although the scope of the claimed subject matter is not limited in this respect. The resulting pixel 712 in the image plane as modulated by the phase modulation pattern of surface phase map 700 is shown at FIG. 7B in irradiance surface plot 710.

Referring now to FIG. 8A and FIG. 8B, an example phase profile of a binary phase modulation pattern and a resulting pixel in the image plane, respectively, in accordance with one or more embodiments will be discussed. As shown in FIG. 8A, surface phase map 800 represents an example phase profile of binary phase modulation pattern capable of being implemented by one or more of the phase modulators described herein, for example transmissive spatial phase modulator 128 of FIG. 1A, reflective spatial phase modulator 134 of FIG. 1B, transmissive spatial phase modulators 146 of FIG. 2, and/or reflective spatial phase modulator 152 of FIG. 3, although the scope of the claimed subject matter is not limited in these respects. As shown in FIG. 8A, the resulting phase profile shown in surface phase map 800 comprise a pattern of binary states such as a first region 810 having a first state and a second region 812 having a second state. The resulting pixel 816 in the image plane as modulated by the phase modulation pattern of surface phase map 800 is shown at FIG. 7B in irradiance surface plot 814.

Although the claimed subject matter has been described with a certain degree of particularity, it should be recognized that elements thereof may be altered by persons skilled in the art without departing from the spirit and/or scope of claimed subject matter. It is believed that the subject matter pertaining to speckle reduction in display systems using transverse phase modulation in a non-image plane and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A scanned beam display, comprising:
one or more light sources to generate one or more light beams;
a scanner module to receive the one or more light beams to generate a displayed image via scanning of the light beams onto a projection surface; and
a spatial phase modulator disposed between the light source and the scanner module to phase modulate the one or more light beams to provide speckle reduction in the display image projected onto the projection surface.

2. A scanned beam display as claimed in claim 1, wherein the spatial phase modulator comprises a transmissive spatial phase modulator or a reflective spatial phase modulator, or combinations thereof, disposed in a beam path of the one or more light beams.

3. A scanned beam display as claimed in claim 1, wherein the spatial phase modulator comprises a binary phase modulator, a multi-state phase modulator, or a continuous phase modulator, or combinations thereof.

4. A scanned beam display as claimed in claim 1, wherein the spatial phase modulator operates on a combined beam of the one or more light beams.

5. A scanned beam display as claimed in claim 1, wherein the spatial phase modulator comprises one or more modulators, one modulator for each respective light source of the one or more light beams.

6. A scanned beam display as claimed in claim 1, wherein the spatial phase modulator is capable of producing orthogonal, or nearly orthogonal, modulation states that create uncorrelated or nearly uncorrelated speckle patterns on a random screen.

7. A scanned beam display as claimed in claim 1, further comprising an aperture to clip one or more of the light beams after modulation by the spatial phase modulator to provide a uniform, or nearly uniform, brightness of the one or more light beams.

8. A scanned beam display as claimed in claim 1, wherein the spatial phase modulator comprises a reflector of the scanner module.

9. A scanned beam display as claimed in claim 1, wherein the spatial phase modulator comprises a multi-pixel phase modulator a nematic liquid crystal (NLC) device, a ferroelectric liquid crystal (FLC) device, an electro-optic material, a flexible membrane, a transmissive device with locally addressable index of refraction, a reflective device with locally addressable index of refraction, a pixilated device comprising multiple plungers actuatable to different longitudinal positions, a single cell liquid crystal (LC) device, a single cell liquid crystal device comprising an electrode on at least one surface having sufficient enough resistance such that different voltages placed on two sides of the electrode will cause a gradient or varying electric field to be imposed across the cell, a diffraction grating, a blazed diffracting grating, an acoustically actuated device, or combinations thereof.

10. A method to reduce speckle in a scanned beam display, the method comprising:
generating one or more light beams;
scanning of the one or more light beams to generate a displayed image projected onto a projection surface; and
phase modulating the one or more light beams prior to said scanning to provide speckle reduction in the display image projected onto the projection surface.

11. A method as claimed in claim 10, said phase modulating comprising transmissively phase modulating, or reflectively phase modulating, or combinations thereof, one or more of light beams.

12. A method as claimed in claim 10, wherein said phase modulating comprises binary phase modulating, multi-state phase modulating, or continuous phase modulating, or combinations thereof.

13. A method as claimed in claim 10, said phase modulating comprising phase modulating a combined beam of the one or more light beams.

14. A method as claimed in claim 10, said phase modulating comprising phase modulating one or more of the light beams separately for one or more respective light sources of the one or more light beams.

15. A method as claimed in claim 10, said phase modulating resulting in orthogonal, or nearly orthogonal, modulation states that create uncorrelated or nearly uncorrelated speckle patterns on a random screen.

16. A method as claimed in claim 10, further comprising aperture clipping one or more of the light beams after said phase modulating to provide a uniform, or nearly uniform, brightness of the one or more light beams.

17. A computing platform, comprising:
a processor and a memory coupled to said processor; and
a scanned beam display capable of displaying an image in response to a command from said processor to display image at least temporarily stored in said memory, the scanned beam display comprising:
one or more light sources to generate one or more light beams;
a scanner module to receive the one or more light beams to generate a displayed image via scanning of the light beams onto a projection surface; and
a spatial phase modulator disposed between the light source and the scanner module to phase modulate the one or more light beams to provide speckle reduction in the display image projected onto the projection surface.

18. A computing platform as claimed in claim 17, wherein the spatial phase modulator comprises a transmissive spatial phase modulator disposed in a beam path of the one or more light beams.

19. A computing platform as claimed in claim 17, wherein the spatial phase modulator comprises reflective spatial phase modulator disposed in a beam path of the one or more light beams.

20. A computing platform as claimed in claim 17, wherein the spatial phase modulator comprises a reflector of the scanner module.
